(19) United States
(12) Patent Application Publication
(10) Pub. No.: US 2013/0206927 A1
(43) Pub. Date: Aug. 15, 2013

(54) Threaded flange plate for hanger rod

(71) Applicant: ELLIOTT GREENFIELD, ELKINS PARK, PA (US)

(72) Inventor: ELLIOTT GREENFIELD, ELKINS PARK, PA (US)

(73) Assignee: GREENFIELD MFG CO INC, PHILADELPHIA, PA (US)

(21) Appl. No.: 13/396,561

(22) Filed: Feb. 14, 2012

(51) Int. Cl. F16L 3/133

(52) U.S. Cl. 248/58

(57) ABSTRACT

A mounting assembly utilizing a shaped plate for connection to a threaded rod. A method of creating cuts to clamp about a second internally threaded plate and then deforming those cuts to provide secure fixation of the threaded plate in the first member to permanently hold and prevent movement of the internally threaded plate forming an assembly. The shaped plate having holes within it for mounting the assembly on a flat surface using suitable fasteners.

### BACKGROUND OF THE INVENTION

The present invention relates to devices for hanging pipes below ceilings and beams, or supporting them from walls and, in particular, to a mounting plate or bracket incorporating threads for receiving a hanger rod used to support piping.

There is a multitude of pipe hanger products utilized by piping contractors in the commercial and industrial piping fields. Generally, these products allow various size pipes to be suspended from ceilings or beams within a facility, as the circuits formed by the piping are routed through a building. These products include clamps, hooks, straps, plates, and brackets, among other items. Hanger rods, for example, are used in suspending a pipe where the upper end of the rod is attached to a bracket mounted to a beam and the lower end of the rod is attached to a ring hanger supporting the pipe. The hanger rod is threaded, and a hole in the bracket which is tapped to receive the threaded rod. The plate is used to spread the load of the rod out to two smaller fasteners which are placed a fixed distance apart by design standards to prevent in the case of wood beams the splitting of the wood and the subsequent failure of the connection.

Further, in the example above, the threaded connection of the hanger rod to the bracket is often limited by the thickness of the bracket. Increased threaded contact is possible using a thicker bracket which increases the bracket weight and cost. In the case of castings a boss would be added.

A typical technique for manufacturing plates and brackets for mounting to ceilings and beams includes a first production line for the fabrication of the plate or bracket with screw or bolt holes and then a second production line for tapping holes for the hanger rods. The production often involves sand casting the plate out of iron. This separation of procedures increases both the time and cost of manufacturing the plates and brackets.

This application enables the combining in one tool the forming and threading of the plate as the plate is formed and the threaded part inserted at the same time in the progressive tool. The threaded section is previously threaded on a nut runner, which continuously threads parts without backing out of the threaded hole, a one directional operation, being very fast and thus less costly.

### SUMMARY OF THE INVENTION

A mounting bracket constructed in accordance with the present invention for hanging a pipe support overcomes the afore noted disadvantages by incorporating a threaded shaped plate which allows an increased threaded connection with a hanger rod and also makes the initiation of the connection with the rod easier.

A mounting member of the present invention comprises a plate-mounting element having at least one mounting hole and another hole to receive a hanger rod. The bracket is shaped to allow an internally threaded plate to stay behind it. The bracket further has cuts in the plate that hold the threaded plate from rotation and keep it in place during transport and installation. The cuts are stamped into the shaped bracket, then after insertion of the threaded plate the cuts are bent so as to trap and firmly hold the contained threaded plate.

A method of the present invention for manufacturing a mounting member constructed in accordance with the present invention comprises the steps of:

1) Fabricating a strip of metal having a length equal to the length of an element of the mounting member;
2) Forming holes in the metal strip;
3) Forming cuts in the metal strip;
4) Forming a depression in the strip and shaping it to allow for a second metal plate;
5) Vertically positioning the second plate behind the hole such that the cuts surround the internally threaded plate; and
6) Pressing the cuts so that the metal strip grips parallel sides of the threaded plate with sufficient force to prevent the threaded plate from moving.

All these steps are incorporated into a progressive tool in a punch press and so all happen simultaneously. A completed part is then ejected on every stroke of the press.

Placing the threaded plate behind the mounting plate removes any dependence on the fastening of the second plate to the structural integrity of the device. Forming out the first plate greatly improves the strength of the assembly and allows the plate to mount flush on the surface.

The manufacture of a mounting member constructed in accordance with the present invention does not require a separate production line or equipment for in line tapping of a hole, and the cost is lowered by utilizing inexpensive prepared plates or nuts. By not taping the hole in the progressive die the rate of production is increased enabling reduced part cost.

Further advantages and applications will become apparent to those skilled in the art from the following detailed description and the drawings referenced herein.

### BRIEF DESCRIPTION OF THE DRAWINGS

FIG. 1 is a perspective view of one embodiment of the present invention, wherein a bracket is coupled via a hanger rod to an adjustable clevis hanger for suspending a pipe;

FIG. 2 is a perspective view of the plate of FIG. 1;

FIG. 3 is a top view of the bracket of FIG. 1;

FIG. 4 is a cross-sectional view taken along lines I-I of FIG. 3. This shows the cut out sections holding the threaded plate;

FIG. 5, 6, 7 are views of the some of but not all of the various shaped internally threaded plates with at least two parallel edges or sides that may be used;

### DETAILED DESCRIPTION OF THE PREFERRED EMBODIMENTS

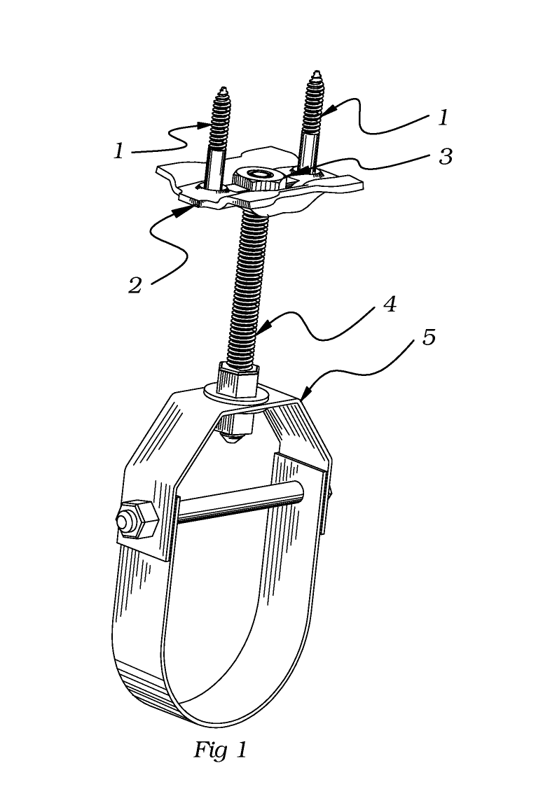

FIG. 1 illustrates a first preferred embodiment of a mounting member in the form of a shaped and formed plate 2 constructed in accordance with the present invention. As shown, the plate 2 is used to mount a pipe hanging support 5 represented here by a clevis hanger (U.S. Pat. No. 2,714,497) to the underside of a wood, concrete, or steel beam (not shown). Generally, this type of plate 2 may be mounted to the beam with drive screws 1 or a lag bolt (not shown), depending upon the size of the piping to be suspended. Drive screws, for example, may be used with the plate 2 for ½- to 2-inch pipes, while the lag bolt is used for up to 4-inch piping. In accordance with the invention, a threaded hanger rod 4 is coupled at its upper end to a threaded plate 3 which has been fixed in the shaped plate 2 by shaped cut outs. A hanger strap 5 is attached to a lower end of the rod 4 by nuts to support a pipe.

Although the hanger strap 5 is shown in the form of a clevis, other types of hangers, such as a loop hanger, J-hanger or others known to those skilled in the art, may be used with the hanger rod 4 to support the pipe (not shown). Alternately, eye rods, bolts, or the like may be used with the bracket 2 to suspend various types of pipe supports or other appliances. As the piping size varies, so too do the appropriate sizes for the hanger and rod support elements.

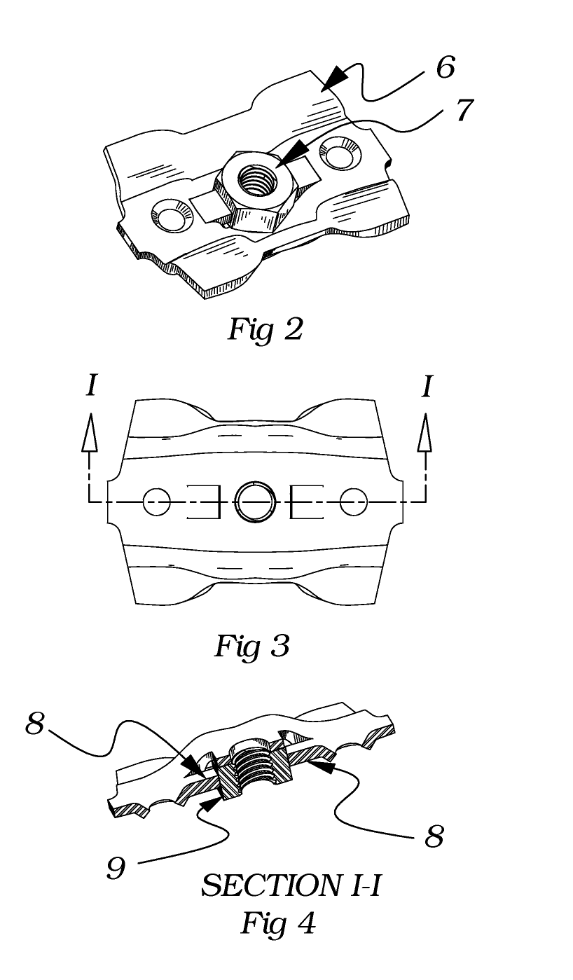

FIG. 2 is a preferred embodiment of the invention showing the underside of the shaped plate 6. Here shown is the placement and captivation of a hex shape 7 on the plate.

FIG. 3 is a front view of the plate pointing out the placement of the section line I-I. The outline of the plate is a result of the forming of the material to allow for the internally threaded plate to lie behind the mounting plate. Forming the plate allows for the threaded plate and mounting plate to lie on the same plane so as to be mounted flush on flat surfaces.

FIG. 4 shows a cut away section of the plate assembly. One here can see the cut section of the internally threaded plate 9 being held in position and trapped by the friction of bent metal cuts 8. These cutouts may be further shaped to increase the force that traps the threaded plate in position.

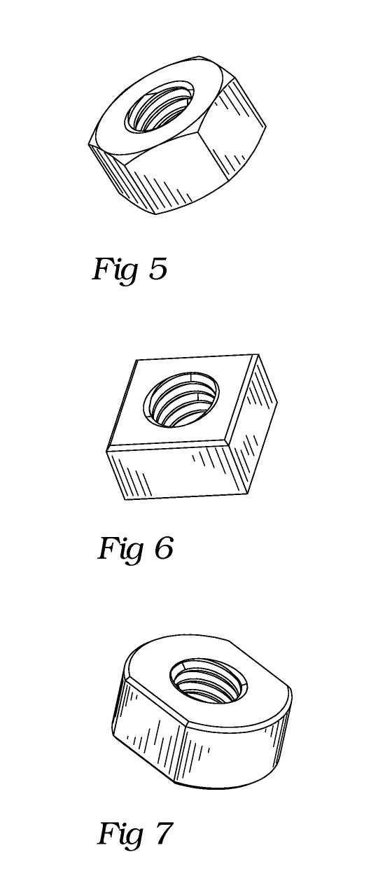

FIG. 5 shows the hex shaped plate used in the previous FIG. 4. FIG. 6 shows a square or rectangular shaped plate that could also be used instead of the hex. FIG. 7 shows a round shape with flats. These flats may then be engaged with the cuts to hold the plate in place.

The embodiments illustrated and described above are provided merely to illustrate possible incarnations of the present invention. Other changes and modifications can be made from the embodiments presented herein by those skilled in the art without departure from the spirit and scope of the invention, as defined by the appended claims.

What is claimed is:

1. An assembly for suspending a pipe or other device from a structure for use with an externally threaded rod or partially threaded stud consisting of two metal plates, the first containing three holes in a linear pattern, this plate having been formed out to enclose a thicker and smaller second metal plate with at least two parallel edges or sides substantially perpendicular to its faces and having within it a centrally located threaded hole, this second metal plate being held in place by two or more shaped edges cut symmetrically about the center hole within the first plate, these cut edges being bent in such a way that they are opposed to each other and lie on the same plane such that they clamp frictionally, in compression, on their edges, to the parallel edges of the second smaller plate, it being held fully behind the first plate within the formed out section such that the central holes of both plates align.

2. A method for suspending a pipe or other device from a structure from an externally threaded rod or partially threaded stud, comprising of:
attaching the externally threaded rod or stud to a means for receiving and supporting the pipe or device when the pipe or device is attached to the lower end of said rod or stud and,
then attaching the upper end of said rod or stud through a metal plate containing three holes in a linear pattern, this plate having been formed out to accommodate a thicker and smaller second metal plate with at least two parallel edges or sides substantially perpendicular to its faces and having within it a centrally located threaded hole, this second metal plate being held in place by two or more shaped edges cut symmetrically about the center hole within the first plate, these cut edges being bent in such a way that they are directly opposed to each other and lie on the same plane such that they clamp frictionally in compression on their edges, to the sides of the second plate, it being held fully behind the first plate within the formed out section to allow the threaded rod or stud to be placed through the central hole within the first plate then screwed into the threaded hole in the second plate, thereby allowing for a locking nut to be installed, and clamped to the front of the first plate, locking the externally threaded rod or stud to it and,
thereafter attaching the first plate through its remaining two holes to a structure using suitable fasteners.
